(19) United States
(12) Patent Application Publication
(10) Pub. No.: US 2010/0139839 A1
(43) Pub. Date: Jun. 10, 2010

(54) INTEGRAL TOOLFACE BREATHING

(75) Inventors: Christopher RIDGARD, Tulsa, OK (US); Jonathan GRIGSON, Broken Arrow, OK (US)

Correspondence Address: PEARNE & GORDON LLP, 1801 EAST 9TH STREET, SUITE 1200, CLEVELAND, OH, 44114-3108, US

(73) Assignee: ADVANCED COMPOSITES GROUP LIMITED, Heanor (GB)

(21) Appl. No.: 12/631,062

(22) Filed: Dec. 4, 2009

Related U.S. Application Data
(60) Provisional application No. 61/120,187, filed on Dec. 5, 2008.

(51) Int. Cl. B29C 65/02

(52) U.S. Cl. 156/87; 156/382

(57) ABSTRACT

A tool on which material (M) can be moulded to form a moulded article, the tool comprising a surface, which may be provided on a surface layer, defining one or more pathways for the removal of gaseous material from beneath the material (M) being moulded on the tool.

### CROSS-REFERENCE TO RELATED APPLICATIONS

This application claims the benefit of U.S. provisional application Ser. No. 61/120,187 filed Dec. 5, 2008 the contents of which are incorporated herein in their entirety by reference.

### BACKGROUND OF THE INVENTION

The present invention relates to tools, particularly but not exclusively to tools for use in the moulding of curable resinous materials including fibre-reinforced resinous composite materials.

Fibre-reinforced resinous composite materials generally comprise reinforcing fibres in a curable resin matrix. The reinforcing fibres are generally insoluble in the resin matrix and act to strengthen and reinforce the resin matrix, particularly once cured. Conventional reinforcing fibres include glass, carbon, aramid, ceramic and others familiar to those skilled in the art.

Articles formed from moulding such materials find application in many situations and industries due to their relative high strength, low weight and corrosion resistance.

Such composite materials are often moulded on a tool. In this specification the term tool is interchangeable with the term mould. The composite material is often placed on a tool surface of a tool on which it is to be moulded in a number of layers. These layers often comprise pre-determined combinations of reinforcing fibre and matrix resin in the form of sheets, tapes and the like, often termed prepregs. The many varieties and constructions of prepregs are well known to those skilled in the art.

Laminating such layers, particularly when relatively heavy in resin, can result in the entrapment of air between the layers. Trapped pockets of air often result in the formation of undesirable voids in the moulded article. In many cases, the presence of such voids can render an article inferior and often unusable.

Further, the resins used in such materials tend to generate gases, generally termed volatiles, during cure (particularly when cure involves elevated temperatures). Such volatiles can also result in the formation of voids in a moulded article, unless the volatiles are removed before cure.

There are a number of known techniques for removing air and volatiles trapped between respective layers of uncured composite material.

A technique that is commonly employed is to subject the composite materials to vacuum conditions to draw the gases from within the laminate, in what is often termed a “vacuum bag process”. In such techniques the material is enclosed in an airtight way between the tool and a polymer bag or membrane and during the moulding and cure cycle, air is drawn from within the enclosure, to withdraw air and volatiles from between the layers of composite materials.

Despite such known techniques, the resultant articles can suffer from undesirable imperfections in the surface formed against the tool surface. Such imperfections are generally surface porosity and voids. This can be especially true of low pressure or oven cures and where the composite materials comprise a honey comb and/or foam layer or core, particularly in areas of the article's surface under such layer or core.

The imperfections are believed to be caused by gaseous material being trapped between the composite material and the tool surface. Such gaseous material can include air that is trapped during the placement of the material on the tool surface and/or volatiles that are produced during the cure of the material. Such gaseous material is isolated from any applied vacuum in known techniques and thus tends not to be removed.

### BRIEF DESCRIPTION OF THE INVENTION

According to the present invention there is provided a tool on which material can be moulded to form a moulded article, the tool comprising a tool surface defining one or more pathways for the removal of gaseous material from beneath material being moulded on the tool.

The tool surface may be provided on a surface layer of the tool, the layer preferably providing one or more pathways for the movement of gaseous material, such as air and/or volatiles, through the layer.

The layer may comprise a fibrous layer defining pathways between the fibres thereof. The layer may comprise a resin impregnated fibrous layer in which the resin preferably does not fully impregnate the fibrous layer, leaving pathways in the layer for air removal. The resin may impregnate the fibrous layer generally from one side thereof, which may facilitate bonding or integrity of the layer and the tool, yet leaving a relatively dry fibrous outer tool surface.

The tool may comprise a tool body which bears the surface. The tool body may bear the surface layer, when provided. The surface layer may be removably located on or in the tool body.

The tool body may comprise a composite material, such as a resinous fibre reinforced composite material. The resin of the fibrous layer may be the same or otherwise compatible with the resinous material of the tool body, at least in the region of the tool body bearing the fibrous layer, to facilitate bonding or integration. Alternatively or in addition the tool body may comprise a metallic or other non-fibre reinforced composite material, such as glass, carbon, aramid and/or ceramic.

Alternatively or in addition, the tool body has the surface formed directly thereon. The surface may be textured to define the said pathway(s). The surface may be textured by abrading the tool body, by moulding or otherwise forming the body to comprise the desired textured surface, by machining, etching, scratching and/or cutting the tool body. The surface may have a network or grid of passages or channels formed therein to provide the said pathway(s).

A semi-permeable membrane or layer may be provided on the surface to extend in use between the surface and the material loaded on the tool to be moulded thereon, the membrane being gas permeable to allow gases, including air and volatiles, to move therethrough from the material to the tool surface, but substantially resin impermeable to prevent resin in the material to be moulded from moving into the surface. This helps to prevent the pathways in the surface from becoming blocked with resin from the material being moulded, thus helping to ensure continued air evacuation during use and potential reuse of the tool.

The semi-permeable membrane may comprise a drapeable polymer material such as ethylene tetrafloroethylene (ETFE).

According to a second aspect of the present invention there is provided a method of moulding an article, comprising locating material to be moulded over a tool surface of a tool as defined in any of paragraphs eleven to eighteen above, enclosing the material between a membrane and the tool to form a substantially vacuum integral enclosure, and withdrawing air from within the enclosure to remove gases from beneath the material, through the surface of the tool.

A semi-permeable membrane or layer may be located between the tool surface and the material to be moulded, to allow gases, including air and volatiles, to move therethrough to the tool surface but substantially preventing resin in the material to be moulded from moving into the surface.

The semi-permeable membrane used may be as described above.

The material may be subjected to conditions for cure thereof, including elevated temperatures. The air may be withdrawn prior to and/or during cure.

According to a third aspect of the present invention there is provided a method of manufacturing a tool, the method comprising forming a surface on a tool body, the surface defining one or more pathways for the movement of gaseous material through the surface.

The surface may be formed by providing a surface layer defining the said one or more pathways, which surface layer may be bonded to, perhaps to form an integral part of the tool body.

The surface and surface layer may be as described herein above.

The level of impregnation of resin from a resinous tool body into the surface layer during manufacture may be controlled using resin flow control means such as fluorinated ethylene propylene (FEP), a low flow syntactic or other layer to control the flow of resin from the tool body into the surface layer, particularly during manufacture of the tool.

### BRIEF DESCRIPTION OF THE DRAWINGS

Embodiments of the present invention will now be described, by way of example only, with reference to the accompanying drawings, in which:

FIG. 1 is a diagrammatic cross-section of a tool according to the present invention;

FIG. 2 is a perspective plan view of the tool of FIG. 1;

FIG. 3 is a diagrammatic cross-section of a tool according to a second embodiment of the present invention;

FIG. 4 is a perspective plan view of the tool of FIG. 3;

FIG. 5 is a diagrammatic cross-section of a tool according to a third embodiment of the present invention;

FIG. 6 is a perspective plan view of the tool of FIG. 5;

FIG. 7 is a diagrammatic cross-section of the tool of FIG. 1 in use in the formation of a moulded article thereon;

FIG. 8 is a diagrammatic cross-section of the tool of FIG. 3 in use in the formation of an article thereon; and

FIG. 9 is a diagrammatic cross-section of the tool of FIG. 5 in use in the formation of an article thereon.

### DETAILED DESCRIPTION OF THE INVENTION

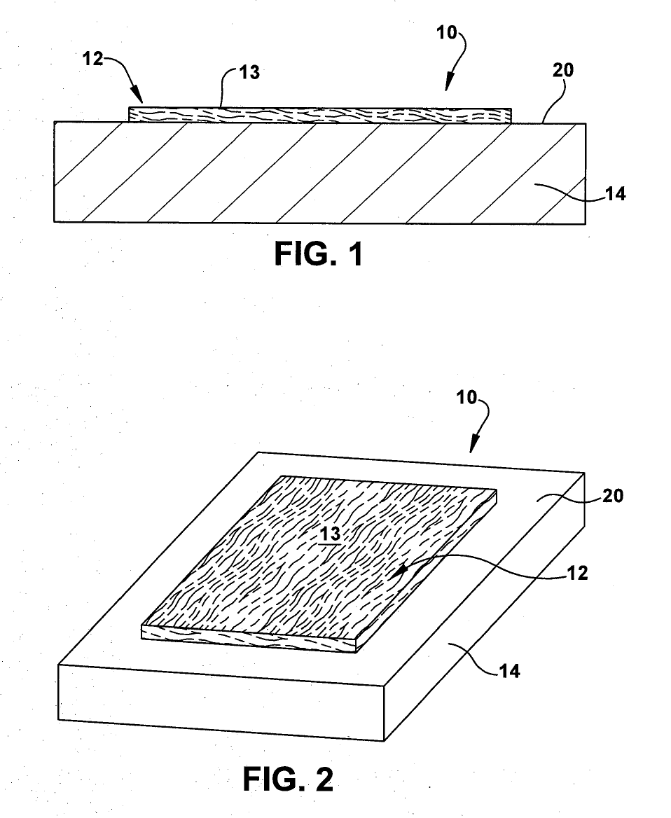

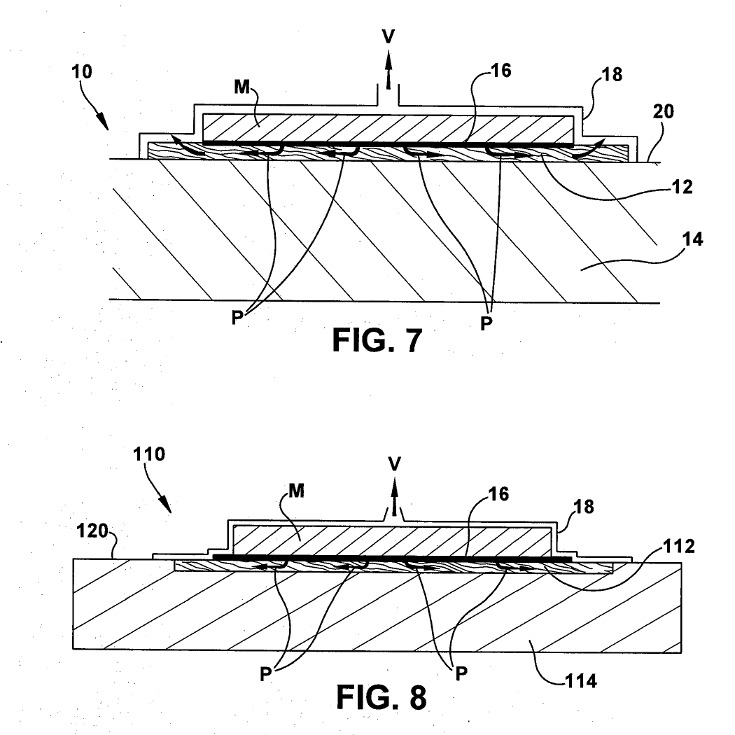

Referring to FIGS. 1, 2 and 7, there is provided a tool 10 on which material M may be moulded to form a moulded article, the tool 10 comprising a surface 12 defining one or more pathways for the removal of gaseous material (illustrated diagrammatically in FIG. 7 by arrows P) from beneath the material M being moulded on the tool 10.

The surface 12 is provided as a surface layer comprising a fibrous material, the pathways being provided by the interstices between the fibres within the layer 12.

In the particular embodiment illustrated in these figures, the layer 12 comprises a degree of resin impregnation. The resin is generally provided to bond the layer 12 to the tool body 14, which is itself comprised of a resinous material as will be described. It is important that the degree of resin impregnation is controlled enabling the control of the degree of porosity or breathability of the surface 12 provided by the pathways. It is envisaged that the surface layer 12 would be in the form of a partially impregnated or sided prepreg, where the resin load is located generally at one surface of the fibrous material with limited impregnation through the thickness of the layer, to leave a sufficient proportion of the fibrous material devoid or substantially devoid of resin. It is this substantially dry portion of the layer that provides the pathways and it is preferred that the surface layer 12 is substantially dry across its entire outer side 13.

The fibrous material may comprise any suitable known fibre reinforcement material such as glass fibre, carbon fibre, aramid, ceramic and/or any others or combinations known to those skilled in the art. It is generally preferable that the resinous material provided in the layer 12 is compatible with that in the tool body 14, to facilitate bonding and integration of the surface layer 12 into the tool body 14. Indeed, the resinous material in the surface may comprise resin from the tool body 14, that impregnated the layer 12 during tool manufacture. The manufacture of the tool 10 can be a simple process. The tool body 14 can be formed according to conventional techniques. The tool surface 20 is prepared to receive the surface layer 12, by shaping to the desired contours using conventional techniques. The layer 12 is then placed on the surface 20 at the appropriate location. Conditions such as elevated temperatures are then applied. If the layer 12 already has a resin load, then the layer 12 is placed so that the resin bearing surface thereof is adjacent to the tool surface 20 so that the resin in the tool body 14 and the surface 12 fuse. If the layer 12 is substantially devoid of resin, the conditions applied are such as to cause resin from the surface 20 to partially impregnate the layer 12 in controlled manner. In a further embodiment, adhesive or bonding resin or other means may be applied between the layer 12 and the surface 20 to secure the layer 12 to the tool body 14.

The degree of impregnation of the resinous material from the tool body 14 into the surface layer 12 is controlled such as by placing a resin flow control layer between the surface layer 12 and the tool body 14. Such resin flow control layers could include an FEP, a low flow syntactic layer or other suitable layer to prevent or control the amount of resin impregnating the surface layer 12 during cure and formation of the tool 10.

The tool body 14 can be formed from any suitable known material for use in the production of tools, such as fibre reinforced resinous composite material, carbon foam, glass foam, metallic foam, polymer and combinations thereof.

FIG. 7 shows a diagrammatic representation of an arrangement for moulding material M on a tool 10. It will be appreciated that the tools illustrated have a very simple, flat tool surface for ease of illustration. It is of course most often the case that the tool surface will be considerably more complex and often have quite intricate geometry. The present invention is easily applicable to more complex geometries as will be apparent to those skilled in the art.

In this particular embodiment, a layer or film 16 of gas permeable/resin impermeable material is located over the surface 12, to prevent resinous material from the material M impregnating the surface 12 during the cure cycle. This helps to maintain the provision of pathways within the surface 12, ensuring efficient and continued air removal and also providing the potential for the tool 10 to be reused.

The composite material M to be moulded is located on the semi-permeable membrane 16 at the desired location on the tool surface 12. The material M can be layered according to conventional techniques and can be of any suitable, known material.

Once the material M has been located, a vacuum bag 18 is located over the material, to enclose the material M and the membrane 16 between the bag 18 and the tool body 14. The bag 18 is sealed against the surface 20 of the tool body 14 according to conventional techniques, to form a vacuum integral seal.

The moulding material M is then subjected to conditions for the particular material M being moulded. The invention finds particular application in the moulding of curable materials, and for these suitable cure conditions are applied for the material concerned. This may include oven or autoclave conditions. Air is withdrawn in the direction of the arrow V from beneath the bag 18. Any gas that is trapped or generated between the material M and the tool body 14 is drawn along the pathways in the layer 12 as shown diagrammatically at P, and out of the enclosure in the direction of arrow V. Any air or volatiles trapped or formed between the membrane 16 and the material M is drawn through the membrane and likewise evacuated through the layer 12. Resin from the material M cannot pass through the membrane 16.

Once the material M is cured, it can be released from the tool 10 and the membrane 16.

It has been found that providing the tool with the breathable surface in this way provides improved surface characteristics of articles moulded thereof, including reduced surface porosity.

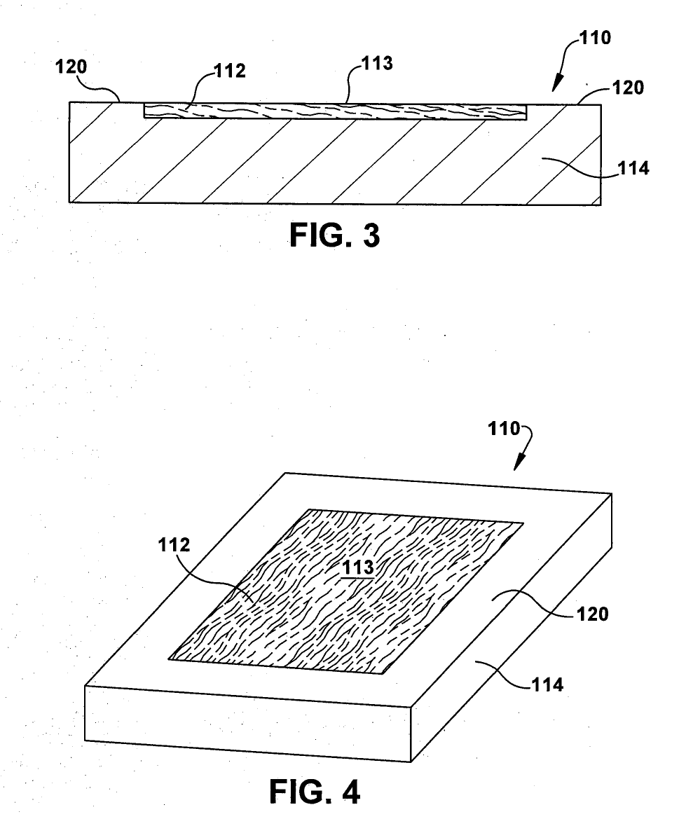

FIGS. 3 and 4 illustrate a tool 110 that is generally similar to the tool 10, but wherein the layer 112 is embedded within the tool body 114 so that the outer, substantially dry side 113 thereof is generally flush with the outer surface 120 of the tool body 114.

FIG. 8 is a diagrammatic illustration of the tool 110 of FIGS. 3 and 4 in use in the formation of the moulded article from material M. The moulding processes used for tool 110 are generally as described above in relation to tool 10.

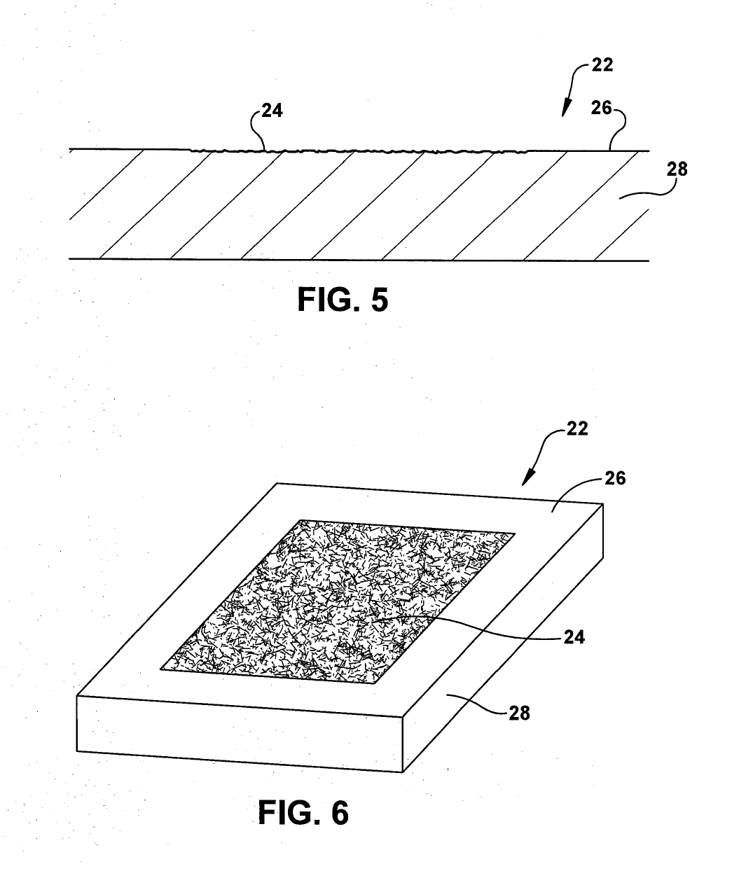

FIGS. 5 and 6 illustrate a tool 22 according to an alternative embodiment of the present invention. In this embodiment, the tool 22 comprises a surface 24 on the tool body defining one or more pathways for the removal of gaseous material from beneath material being moulded on the tool 22. The surface 24 is textured, the texture formed by techniques such as abrading the outer surface 26 of the tool body 28 to form a textured architecture in the surface at a desired and predetermined area on the tool body 28.

The textured surface 24 provides the pathways through the architecture of the surface 24.

The surface 24 can be formed other suitable processes such as by moulding the textured surface into the outer surface 26 during the formation of the tool body 28. Alternatively or in addition the textured surface 24 can be formed by other techniques such as etching, scratching, cutting and/or machining the surface 26.

The pathways in the surface 24 may also be formed by cutting a network of passages or channels over the surface 24.

When using the tool 22 to mould material thereon, a gas permeable/resin impermeable membrane 16 would generally be located over the surface 24, as described above in relation to the methodology of moulding using tool 10. Again this is considered advantageous in preserving the pathways to ensure efficient air removal and potential reuse of the tool.

However, if the tool body 28 is made of material to which the material M can be moulded thereon with little or no adhesion, then the intermediate semi-permeable membrane may not be required. For example, if the tool surface 26 comprises aramid and the material to be moulded thereon is thermoset resin-based materials, then the intermediate membrane may not be required.

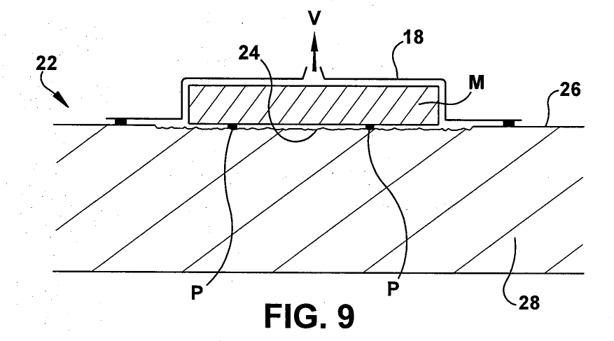

FIG. 9, in a diagrammatic illustration of the tool 22 in use in the moulding of material M thereon. The techniques are essentially as described above in relation to the aforedescribed embodiments. In this illustration the semi-permeable membrane is not shown, but if used, it would be located between the material M and the surface 28.

Various modifications may be made without departing from the spirit or scope of the present invention.

The surface layer 12, 112 may be removably mounted on a tool surface, thus enabling the surface layer 12, 112 to be selectively removed possibly for replacement or cleaning. In such cases, the use of the semi-permeable membrane may not be required.

The airways may be formed in the surface layer by any suitable means, and provided in any suitable form other than or in addition to via the interstices of a fibrous material. The surface layer may have channels or passages formed therein, including a network of such formations to provide a network or grid of pathways in the surface. Alternatively or in addition the airways may be formed in the surface layer according to other techniques discussed above including abrading, scratching, cutting, moulding, etching and such like.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

What is claimed is:

1. A tool on which material can be moulded to form a moulded article, the tool comprising a tool surface defining one or more pathways for the removal of gaseous material from beneath material being moulded on the tool.

2. A tool as claimed in claim 1, in which the tool surface is provided on a surface layer of the tool.

3. A tool as claimed in claim 2, in which the tool surface provides one or more pathways for the movement of gaseous material through the layer.

4. A tool as claimed in claim 2, in which the surface layer comprises a fibrous layer defining pathways between the fibres thereof.

5. A tool as claimed in claim 2, in which the surface layer comprises a resin impregnated fibrous layer.

6. A tool as claimed in claim 2, in which the surface layer comprises a resin impregnated fibrous layer in which the resin does not fully impregnate the fibrous layer, leaving pathways in the layer for removal of gases.

7. A tool as claimed in claim 2, in which the surface layer comprises a resin impregnated fibrous layer wherein the resin impregnates the fibrous layer generally from one side thereof, which facilitates bonding or integrity of the layer and the tool, yet leaving a relatively dry fibrous outer tool surface.

8. A tool as claimed in claim 1, in which the tool comprises a tool body which bears the surface.

9. A tool as claimed in claim 8, in which the tool body bears a surface layer, when provided.

10. A tool as claimed in claim 8, in which a surface layer is removably located on or in the tool body.

11. A tool as claimed in claim 8, in which the tool body comprises a composite material.

12. A tool as claimed in claim 8, in which the tool body comprises a resinous fibre reinforced composite material.

13. A tool as claimed in claim 8, in which a surface layer comprises a resinous fibrous layer, the resin of which is the same or otherwise compatible with resinous material of the tool body, at least in a region of the tool body bearing the resinous fibrous layer, to facilitate bonding or integration.

14. A tool as claimed in claim 8, in which the tool body comprises a metallic or other non-fibre reinforced composite material.

15. A tool as claimed in claim 8, in which the tool body comprises glass, carbon, aramid and/or ceramic.

16. A tool as claimed in claim 8, in which the tool body has the surface formed directly thereon.

17. A tool as claimed in claim 8, in which the surface is textured to define pathway(s) for the removal of gaseous material.

18. A tool as claimed in claim 8, in which the surface is abraded on the tool body, moulded, machined, etched, scratched and/or cut into the tool body to provide a desired textured surface.

19. A tool as claimed in claim 1, in which the surface has a network or grid of passages or channels formed therein to provide pathway(s) for the removal of gaseous material.

20. A tool as claimed in claim 1, in which a semi-permeable membrane or layer is provided on the surface to extend in use between the surface and the material loaded on the tool to be moulded thereon, the membrane being gas permeable to allow gases, to move therethrough from the material to the tool surface, but substantially resin impermeable to prevent resin in the material to be moulded from moving into the surface.

21. A tool as claimed in claim 20, in which the semi-permeable membrane comprises a drapeable polymer material.

22. A tool as claimed in claim 20, in which the semi-permeable membrane comprises ethylene tetrafloroethylene (ETFE).

23. A method of moulding an article, comprising locating material to be moulded over a tool surface of a tool as defined in claim 1, enclosing the material between a membrane and the tool to form a substantially vacuum integral enclosure, and withdrawing air from within the enclosure to remove gases from beneath the material, through the surface of the tool.

24. A method as claimed in claim 23, in which a semi-permeable membrane or layer is located between the tool surface and the material to be moulded, to allow gases, including air and volatiles, to move therethrough to the tool surface but substantially preventing resin in the material to be moulded from moving into the surface.

25. A method as claimed in claim 24, in which the semi-permeable membrane is as claimed in claim 21.

26. A method as claimed in claim 23, in which the material is subjected to conditions for cure thereof.

27. A method as claimed in claim 23, in which the air is withdrawn prior to and/or during cure.

28. A method of manufacturing a tool, the method comprising forming a surface on a tool body, the surface defining one or more pathways for the movement of gaseous material through the surface.

29. A method as claimed in claim 28, in which the surface is formed by providing a surface layer defining the said one or more pathways.

30. A method as claimed in claim 28, in which a surface layer is bonded to the tool body to define the said one or more pathways.

31. A method as claimed in claim 29, in which the level of impregnation of resin from a resinous tool body into the surface layer during manufacture is controlled using resin flow control means.

32. A method as claimed in claim 29, in which the level of impregnation of resin from a resinous tool body into the surface layer is controlled using a fluorinated ethylene propylene (FEP) layer or a low flow syntactic layer between the tool body and the surface layer.
